(19) United States
(12) Patent Application Publication
(10) Pub. No.: US 2012/0296880 A1
(43) Pub. Date: Nov. 22, 2012

(54) Method and System for Building and Using a Centralized and Harmonized Relational Database

(76) Inventors: Zhongzhong Chen, Shanghai (CN); Jean-Philippe Coppé, San Francisco, CA (US)

(21) Appl. No.: 13/423,458

(22) Filed: Mar. 19, 2012

Related U.S. Application Data
(63) Continuation of application No. PCT/EP2010/005745, filed on Sep. 20, 2010.
(60) Provisional application No. 61/243,855, filed on Sep. 18, 2009.

(51) Int. Cl. G06F 17/30

(52) U.S. Cl. 707/692; 707/741; 707/706; 707/E17.002; 707/E17.108

(57) ABSTRACT

A method for building and maintaining centralized and harmonized relational database for acquiring, managing, filtering, integrating and accurately analyzing peptide and protein data based on functional class is described. In addition, a computer-based system comprising the above database and analysis tools for mining and analyzing the protein/peptide data stored in the database is provided. The database is built using curated and validated protein specific data and does not rely on probabilistic or predictive approaches to derive protein information indirectly from genomic or gene-expression data.

### CROSS-REFERENCE TO RELATED APPLICATIONS

The present application, pursuant to 35 U.S.C. §365(c), is a continuation of co-pending International Patent Application No. PCT/EP2010/005745 filed Sep. 20, 2010, which claims the benefit of priority to U.S. Provisional Patent Application No. 61/243,855 filed Sep. 18, 2009.

### TECHNICAL FIELD

The present subject matter relates generally to computer systems and database management. More particularly, the present subject matter relates to a method and system for creating and maintaining a centralized and harmonized molecular database containing molecules of a given functional class. The present subject matter also includes systems and methods for searching, analyzing, and representing the molecular data stored in the database.

### BACKGROUND

Recent advances in monitoring protein-protein interactions and enzyme-substrate affinity have led to an acceleration in the amounts of protein specific information being generated. Such increasing knowledge has the potential to improve the time consuming and cost intensive process of drug development as well as make pharmaco-kinetic studies and predictive approaches more efficient. However, few databases compile this information in a centralized manner, or with the fidelity needed to accurately manage, analyze and utilize the benefits such a wealth of information can offer. This lack of a centralized and curated database is of particular concern when attempting to ascertain the biomedical relevance of molecular networks, for example associating enzymes to their exact target sequences within substrate molecules.

Many public or privately owned databases exist, but these databases only partially gather scientific information, or focus on a specific lattice of biological characteristics. Knowledge is widely scattered and difficult to retrieve concurrently, or sequentially. Another major imperfection across databases is the co-existence of multiple identification systems, depending on the applications the database was designed to support, or based on developer preferences. The use of an improper name, or the lack of a stable primary identifier does not allow for later updates or for network analysis. In addition, most databases do not rely on curation steps that eliminate redundancy and prevent the compilation of inaccuracies. This situation has led to the inclusion and propagation of human and computer generated errors in databases and datasets.

These limitations systematically lead to inexact or misleading search results, retrieval of inappropriate or incomplete information, scientific redundancy or overlap, and incomplete access to existing data. Moreover, because of the inherent structure of storage and usage of scientific knowledge, mistakes ‘hidden’ or harbored within datasets or global databases can potentially propagate rapidly and cripple other projects, especially in the field of systems biology and its derivative applications.

In addition, many of the current repositories of protein data are built from a “gene perspective,” that is the protein data is derived primarily from gene expression profiles. With the underlying assumption that protein data can be directly correlated to gene expression data, these data sets often rely on probabilistic and predictive methodologies to derive the protein specific information. Further, many gene expression studies rely on the analysis of diseased cells leading to a large bias in data interpretation of true functionality (i.e. function under pathological conditions versus normal conditions). While examining gene expression data can be useful and informative, it is the translated proteins, and any resulting post-translational modifications, that are actively responsible for maintaining the delicate balance between healthy and diseased cells, tissues and organisms. Therefore, understanding what is happening at the protein level can greatly enhance, and some times be preferable to, understanding what is happening at the level of gene expression. Preferably this information would be derived directly from accurate and validated protein data rather than through probabilistic analysis of genomic or gene-expression data.

The current format of scientific knowledge accessibility and content represents an outstanding obstacle to contemporary technologies and to the understanding of biological complexity. Developing a strategy to overcome these inconsistencies is by now imperative and would be highly valuable to any entity related to life science research and development.

### BRIEF SUMMARY

The present methods and systems address the aforementioned deficiencies in the art by providing a method for building and maintaining a centralized and harmonized relational database for acquiring, managing, filtering, integrating and accurately analyzing molecular data. In addition, the present methods and systems provide a computer-based system comprising the above database and analysis tools for mining and analyzing the molecular data stored in the database, including graphical interfaces that allow for direct and intuitive identification of relationships between different molecules in the database

In one aspect, a method for building and maintaining a centralized and harmonized relational database is provided. The database contains molecular data on all molecules known to be associated with a given functional class. In one exemplary embodiment the database is an effector/substrate database containing records on all effectors of a particular class and their substrates. In one exemplary embodiment, the database contains protein and peptide data related to enzymes and their substrates. In another exemplary embodiment, the database contains protein and peptide data related to kinases and their substrates. In yet another exemplary embodiment, the database contains protein and peptide data related to proteases and their substrates.

In one exemplary embodiment, the method for building an effector/substrate database comprises the following steps: a) generating a reference index; b) identifying records in the reference index associated with a particular class of effector and/or substrate; c) generating a primary index comprising the records identified as associated with the particular class of effector and/or substrate and assigning to each record a unique database identifier; d) identifying additional records in one or more external databases associated with the particular class of effector and/or substrate; e) verifying that the additional records contain a primary identifier f) associating a primary identifier with any remaining additional records, and g) adding any remaining additional records not associated with a primary identifier to a watch index. Those additional records in steps e) and f) which contain or can be associated with a primary identifier are added to the primary index. The above steps may be performed at regular repeating intervals to insure that records are updated, or added as additional data becomes available. In addition, the database may be built from an effector perspective, wherein all effectors of a given class are first identified in step b) and associating the effector records with corresponding substrate records in steps c) and d). Alternatively the database may be built from a substrate perspective, wherein all substrates of a given class are first identified in step b) and the associated with corresponding effector molecules in steps c) and d).

In one exemplary embodiment, the effector may be an enzymatic peptide or protein, or an enzymatic nucleic acid molecule. Where the effector and/or substrate records are based on molecules comprising an amino acid or nucleic acid sequence, the method may further comprise the additional steps of checking for and removing any redundant sequences found in the final data set and curating incorrect sequences. For all effector and substrate molecules the method may further comprise validating label annotation, and adjusting topology of the records in the primary index.

The method may also further comprise a ranking step that assigns weighted values to relationships between records in the database. The weighted values between records may be used to assist in the generation of functional networks. The weighted values can be based on such factors as level of specificity between two proteins or peptides in the database. In one exemplary embodiment, the weight values of the ranking system are determined by the number of unique interactions between one enzyme and any of its substrates; each arrow linking an enzyme to its downstream substrate having a width reflected by the number of sites at which the enzyme modifies the substrate.

The present method may also include a target validation step comprising the generation of a target index and a substrate index. For example, a protein target record may have modification position information associated with it as well as peptide information comprising the modification site and flanking amino acids. The target validation step insures that the reported modification site and/or peptide information associated with the record is always validated against the most current version of the protein sequence. The target validation step further distinguishes between validated targets and candidate substrates. Sources of targets of a given class of effector may come from pre-existing external databases specific for target data, targets identified during the build of the primary index above, or experimental data generated de novo. The target and substrate index may be maintained as an index or table within the primary database or maintained in a separate external database. The generation of the target and substrate index may comprise for each record the following steps: verifying if literature support is available; determining if information on the type of modification is available; validation or assignment of a primary identifier; determining if modification position and/or sequence information is available; and validation of position information. Records for which no position information is available, or for which the position information could not be validated, are added to the substrate index. Those records for which validated position information is available are added to the target index.

In another aspect, a computer system for searching and analyzing the effector and substrate data contained in the centralized and harmonized database is provided. The computer system comprises, at least, a user interface and the above described database. In one exemplary embodiment the user interface is a search engine and supporting software. The user interface allows a user to search and analyze the protein and peptide data in the database using different sets of analysis tools. The present invention can be used to study and define molecular or chemical modifications, including post-translational modifications, as well as the unique, exact sites of modification within a given substrate molecule. The data in the database within the computer system is subdivided into cassettes, each cassette allowing the user access to various subsets of analysis tools and data within the database. The computer system is capable of rendering search results as a three dimensional (3D) network based on various characteristics such as, but not limited to, protein-protein specificity, protein and associated molecular pathways, and protein and associated medical conditions.

### BRIEF DESCRIPTION OF THE DRAWINGS

FIG. 1A is a block diagram of a client-server intranet for providing database services in accordance with one embodiment of the invention.

FIG. 1B is a schematic representation of the various software document entities that may be employed by the FIG. 1A client-server intranet to provide biological information in response to user queries.

FIG. 2 is a logic flow diagram illustrating an exemplary embodiment of a method for creating and maintaining a centralized and harmonized protein and peptide database.

FIG. 3 is a logic flow diagram illustrating an exemplary submethod or routine of FIG. 2 for identifying and associating a protein record with a corresponding primary identifier.

FIG. 4 is a logic flow diagram illustrating an exemplary embodiment of a target validation method.

FIG. 5 is a logic flow diagram illustrating an exemplary submethod or routine of FIG. 4 for validating modification position information on a candidate target protein.

FIG. 6A-B are alternative views of a graphic showing the results of a multi-protein search rendered in an exemplary systemic network layout using a computer system of the present invention.

FIG. 7 is a graphic showing the results of a multi-protein search rendered in an exemplary hub network layout using a computer system of the present invention.

FIG. 8 is a graphic showing an exemplary protein interface view depicting the relationship between a searched protein with other proteins in a multi-protein search rendered by a computer system of the present invention.

FIG. 9 is a three dimensional graphical representation of a searched protein and all related substrates rendered using a computer system of the present invention.

### DETAILED DESCRIPTION

The present invention may be embodied in program modules that run in a main frame or relational database environment. The present invention can comprise a computer system that can create and maintain one or more indices for accumulating and updating information related to effector and substrate molecules based on biological function or characteristics. Such information can include, but is not limited to, a standardized name, a standardized symbol, associated aliases, one or more amino acid sequences, one or more mRNA sequences, SNP information, miRNA information, molecular and functional networks, protein-protein interactions, effector and substrate activity, effector and substrate function, effector and substrate localization (i.e. within cells and organelles as well as tissues), functions and dysfunctions, pathway information (i.e. KEGG, GO), sites of modification, antigenicity, associated pathologies (i.e. MESH, HUGO, OMIM), small molecule inhibitors and activators, orthology, structural information including three-dimensional structure data or domain information (HGNC, HPRC), and citation index. Each effector and substrate record may further comprise links to information stored in external databases such as full length gene or genomic sequences, links to supporting scientific literature, and research tools available from third party vendors (i.e. siRNA, antibodies).

### Database and Computer System Environment

Although the illustrative embodiments will be generally described in the context of program modules running in a database, those skilled in the art will recognize that the present invention may be implemented in conjunction with operating system programs, or with other types of program modules for other types of computers. Furthermore, those skilled in the art will recognize that the present invention may be implemented in either a stand-alone, or in a distributed computing environment, or both. In a distributed computing environment, program modules may be physically located in different local and remote memory storage devices. Execution of the program modules may occur locally in a stand-alone manner or remotely in a client server manner. Examples of such distributed computing environments include local area networks and the Internet.

The detailed description that follows is represented largely in terms of processes and symbolic representations of operations by conventional computer components, including a processing unit (a processor), memory storage devices, connected display devices, and input devices. Furthermore, these processes and operations may utilize conventional computer components in a heterogeneous distributed computing environment, including remote file servers, computer servers, and memory storage devices. Each of these conventional distributed computing components is accessible by the processor via a communication network.

The processes and operations performed by the computer include the manipulation of signals by a processor and the maintenance of these signals within data structures resident in one or more memory storage devices. For the purposes of this discussion, a process is generally conceived to be a sequence of computer-executed steps leading to a desired result. These steps usually require physical manipulations of physical quantities. Usually, though not necessarily, these quantities take the form of electrical, magnetic, or optical signals capable of being stored, transferred, combined, compared, or otherwise manipulated. It is convention for those skilled in the art to refer to representations of these signals as bits, bytes, words, information, elements, symbols, characters, numbers, points, data, entries, objects, images, files, or the like. It should be kept in mind, however, that these and similar terms are associated with appropriate physical quantities for computer operations, and that these terms are merely conventional labels applied to physical quantities that exist within and during operation of the computer.

It should also be understood that manipulations within the computer are often referred to in terms such as creating, adding, calculating, comparing, moving, receiving, determining, identifying, populating, loading, executing, etc. that are often associated with manual operations performed by a human operator. The operations described herein can be machine operations performed in conjunction with various input provided by a human operator or user that interacts with the computer.

In addition, it should be understood that the programs, processes, methods, etc. described herein are not related or limited to any particular computer or apparatus. Rather, various types of general purpose machines may be used with the program modules constructed in accordance with the teachings described herein. Similarly, it may prove advantageous to construct a specialized apparatus to perform the method steps described herein by way of dedicated computer systems in specific network architecture with hard-wired logic or programs stored in nonvolatile memory, such as read-only memory.

Referring now to the drawings, in which like numerals represent like elements throughout the several Figures, aspects of the present invention and the illustrative operating environment will be described.

### Method for Building and Maintaining Centralized and Harmonized Protein Database

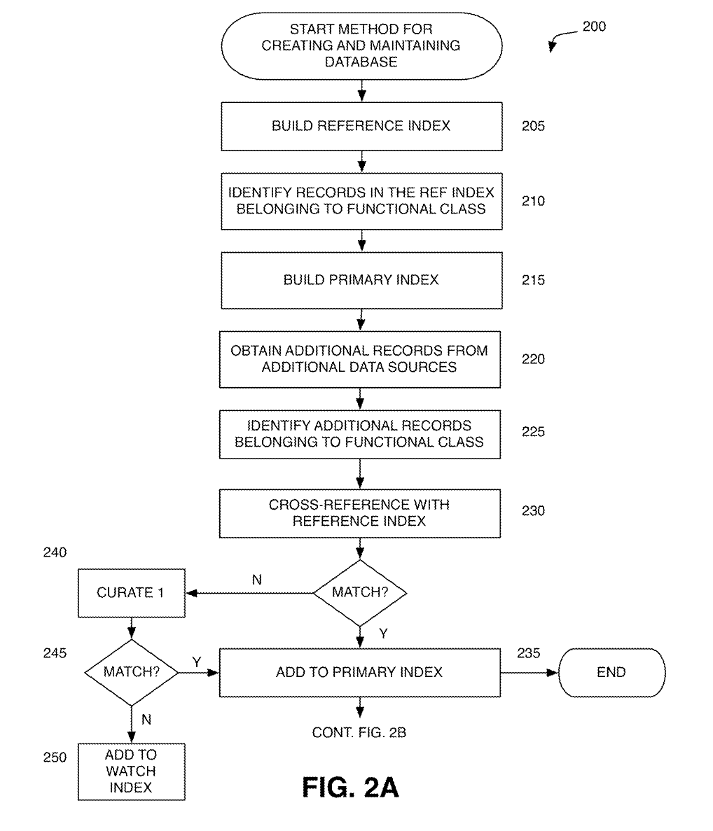

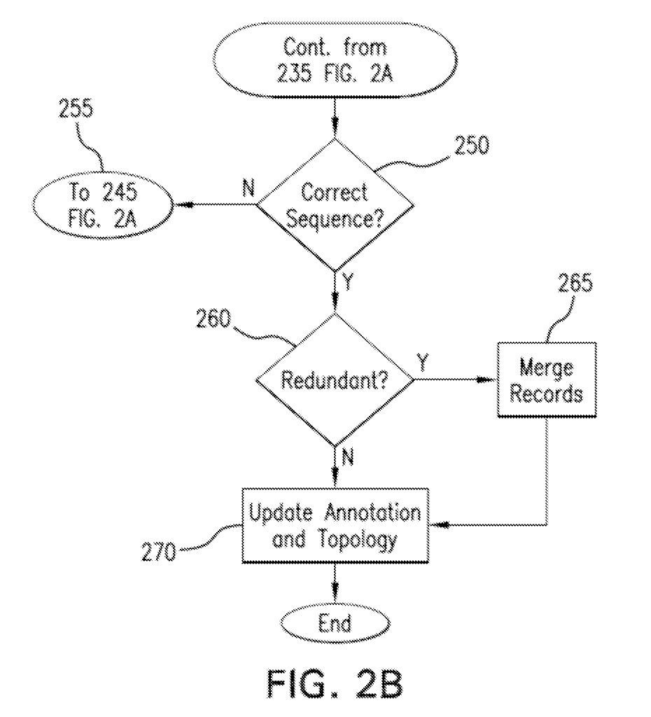

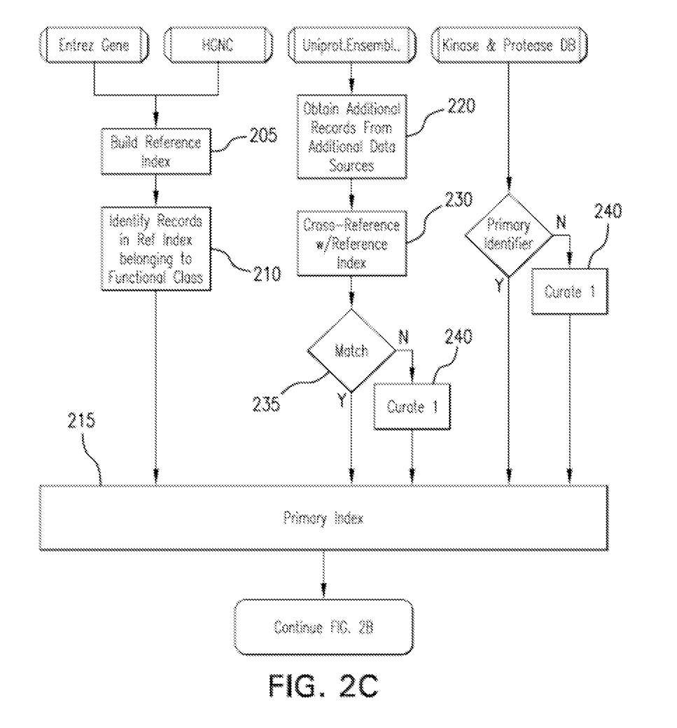

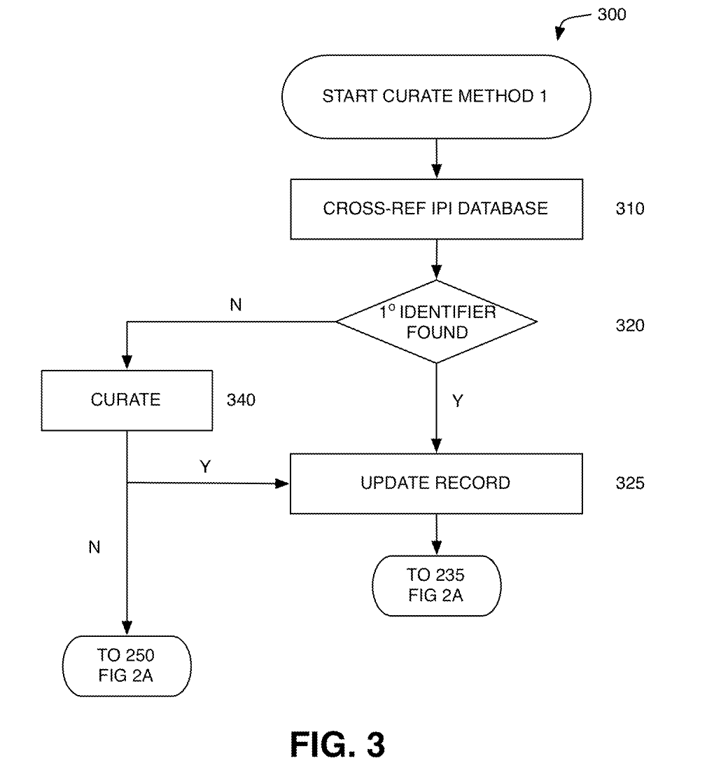

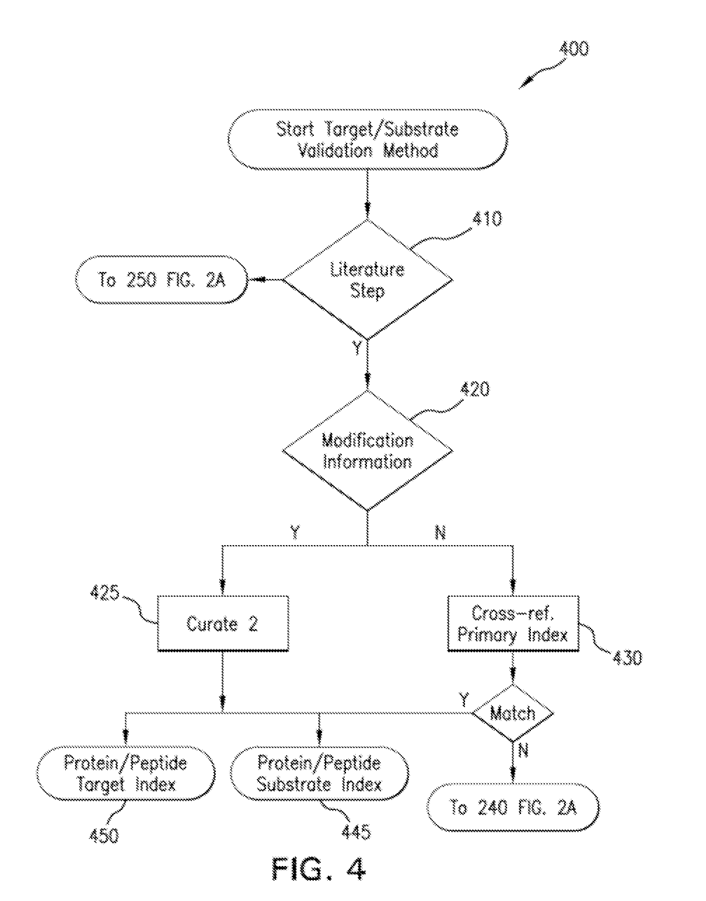

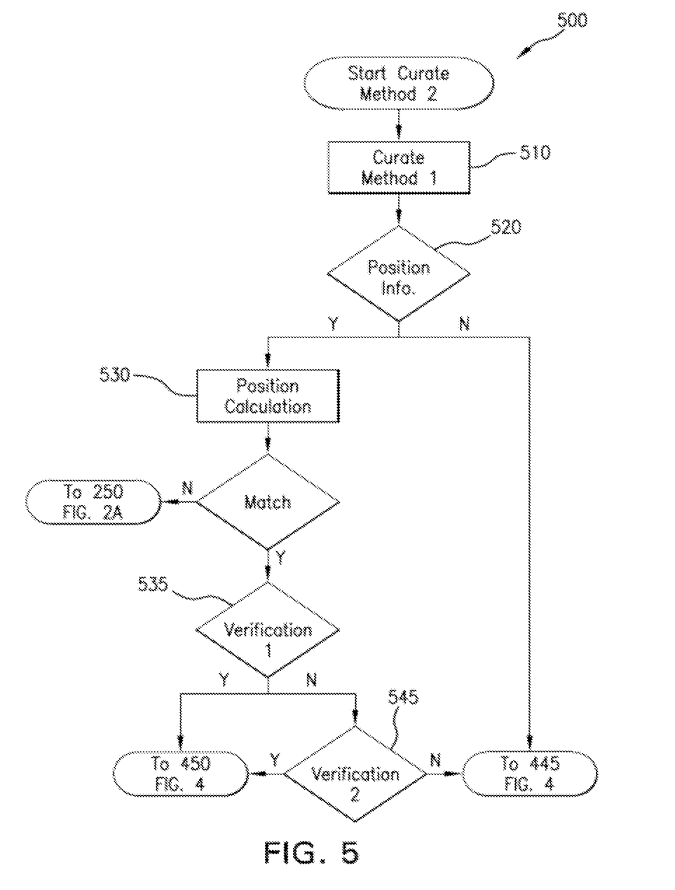

Referring now to FIG. 2A and FIG. 2B, these figures illustrate an exemplary logic flow diagram for creating and maintaining a database. More specifically, the logic flow diagram illustrated in FIG. 2 illustrates a computer-implemented process for creating and maintaining the database that compiles information from multiple data sources. The logic flow described in FIG. 2 is the core logic of the top-level processing loop of the computer system, and as such may be executed repeatedly.

It is noted that the logic flow diagram illustrated in FIG. 2A and FIG. 2B can illustrate a process that occurs after initialization of several of the software components. That is, in the exemplary programming architecture, several of the software components or software objects that are required to perform the steps illustrated in FIG. 2 can be initialized or created prior to the process described by FIG. 2. Therefore, one of ordinary skill in the art will recognize that several steps pertaining to initialization of the software objects may not be illustrated.

Certain steps in the processes described below preferably precede others for the method and system to function as described. However, the present methods and systems are not limited to the order of the steps described if such order or sequence does not alter the functionality of the present invention. That is, it is recognized that some steps may be performed before or after other steps or in parallel with other steps without departing from the scope and spirit of the subject matter described herein.

For purposes of providing a detailed explanation of the invention only, the following paragraphs will detail the method steps as it relates to the building of an enzyme and substrate database. One of ordinary skill in the art will recognize that the present method can be modified to build a database containing information regarding other effector and substrate classes without departing from the overall scope and spirit of the invention.

Beginning in FIG. 2A, the method of 200 starts by creating and maintaining a Reference Index. The Reference Index is created by cross-referencing the records in a database containing protein sequences with a standardized gene nomenclature database in step 205. The records in the protein sequence database are cross-referenced with records in the standardized gene nomenclature database using a common primary identifier. Once a matching primary identifier is found, data from the two records are merged and added to the Reference Index and given a unique database identifier. In one exemplary embodiment, the protein sequence database is the Entrez database maintained by the National Center for Biotechnology Information (NCBI), the standardized gene nomenclature database is the HGNC database maintained by the HUGO Gene Nomenclature Committee, and the primary identifier is a Refseq number common between records contained in the two databases. In another exemplary embodiment, the primary identifier is an Entrez Gene ID common to both records in the databases.

The HGNC database contains a standardized gene name and a standardized gene symbol for each known human gene. In addition, each record list one or more of the following; known aliases, the corresponding Entrez Gene ID, associated RefSeq numbers, chromosome location information, CCDS (Consensus CDS Protein Set) ID, Pubmed ID(s), Ensembl ID, OMIM (Online Medelian Inheritance in Man) ID, and UniProt ID.

Each Entrez Gene ID in the Entrez database is associated with a Reference Sequence (RefSeq) nucleotide and protein record. The main features of the RefSeq collection include non-redundancy, explicitly linked nucleotide and protein sequences, updates to reflect current knowledge of sequence data and biology, data validation and consistency, a distinct identifier, and ongoing curation by NCBI staff and collaborators, with reviewed records indicated. Additional information typically associated with an Entrez Gene ID record includes; known aliases, chromosome location information, GeneRIFS (list of known functions), list of known protein-protein interactions (i.e. enzyme-substrate relationships) with supporting PubMed ID(s), Gene Ontology information (i.e. functions, processes, cellular localization), microRNA, and associated SNPs.

Each record in the Reference Index comprises at least a unique database identifier, a standardized symbol, a standardized name, a RefSeq protein identifier, and optionally a RefSeq nucleotide identifier. Additional information associated with each record can be maintained directly with the record in the Reference Index, or stored in separate tables or indices based on data type and associated with the appropriate record via the unique database identifier. In addition to information associated with the corresponding HGNC or Entrez record, information contained in additional literature sources such as handbooks and text books may be added to or associated with records in the Reference Index via an identifier such as a PubMed Id or ISBN number. In one exemplary embodiment, additional information is not retrieved and associated with the appropriate record until after step 210, described below, is executed.

Next, in step 210, records within the Reference Index associated with a specified class of effector and/or substrate are identified. In one exemplary embodiment, the effector class is enzymes. In another exemplary embodiment, the effector class is kinases. In yet another exemplary embodiment, the effector class is proteases. In another exemplary embodiment, the effector class is selected from the group comprising, but not limited to, enzymes with the following activies; acetylation, deacetylation, alkylation, dealkylation, amidation, deamidation, carboxylation, decarboxylation, glycosylation, deglycosylation, phosphorylation, dephosphorylation, formation of disulfide bridges, desulfination, farnesylation, defarnesylation, glycosyl phophatidyl transfer and removal, glutathionylation, hydroxylation, methylation, demethylation, myristoylation, demyristoylation, neddylation, deddylation, nitration, palmitoylation, prenylation, depreynylation, S-nitrosylation, sumoylation, desumoylation, transglutamination, ubiquitination and proteolytic cleavage.

In one exemplary embodiment, step 210 may comprise searching one or more scientific literature databases using one or more key words associated with the class of effector and/or substrate and retrieving the references. The retrieved references are then searched using a natural language processing algorithm, such as merge sort or quicksort in Perl, Arrays.sort in Java, or timsort in Python, to identify those references containing either the standardized name or standardized symbol of each record in the Reference Index. Records identified in step 210 as associated with the class of effector and/or substrate are then added to a primary index in step 215.

At this point, data from additional databases may be gathered at step 220. Records from each additional database associated with the class of effector and/or substrate are then identified in step 225 using the methodology described in step 210 above. Data from any suitable protein or peptide data source may be included. Examples of additional protein or peptide databases that may be added include, but are not limited to, UniProtKB/Swiss-Prot, Ensembl, EMBL, CCDS, and PDB. The database may be a general protein or peptide data repository, or it may be specific for the given class of effector or substrate, such as kinases or proteases and their substrates. Next, in step 230, the records are checked to verify association with a primary identifier. Those records with an existing primary identifier are added to the primary index in step 235. If the record is already present in the primary index 215, any additional protein data not previously associated with the record may be merged with the record, or added to the appropriate table or index. Records that do not have a primary identifier invoke sub-method 240. Further details of sub-method 240 are discussed below in respect to FIG. 3. Protein or peptide data of records that are successfully matched in 240 are also added directly to the Primary Index. Records that cannot be successfully matched in 240 are either excluded, or can be added to a separate watch index at step 245. Records in the watch index can then be monitored for additional updates of information that will allow a successful and accurate match during successive iterations of the primary method 200.

As previously noted, the step of the process are not limited to the order of the steps described if such order or sequence does not alter the functionality of the present invention. FIG. 2C provides an alternative view indicating how various steps from 210 to 240 can be carried out in parallel. It is important to note that at least step 205 must be completed before parallel initiation of steps 210-240.

After the Primary Index is completed or updated in step 235, additional steps may be executed to ensure record quality and add or modify information associated with each record. These steps are shown in FIG. 2B and may include curating incorrect sequences 250, removing or merging data associated with redundant sequences 260, checking record label annotation and adjusting record taxonomy 270.

In one exemplary embodiment, routine 250 is programmed to execute the following steps comprising the use of a sequence alignment algorithm such as, but not limited to, BLAST (Basic Local Alignment Search Tool) the Smith-Waterman algorithm, or other pattern matching computer implemented methods such as the use of the regular expression syntax in Perl to identify incorrect sequences. All sequence data is compared with the sequence associated with the primary identifier in the Reference Index (i.e. the sequence contained in the Entrez database for a given RefSeq). Any sequence that does not match a sequence in the Reference Index is added to the Watch Index 255.

In one exemplary embodiment, routine 260 is programmed to execute the following steps comprising the use of sequence comparison methods similar to those used in routine 250 in order to identify redundant sequences. When a redundant sequence is found, a cross-reference is made with Entrez to verify that the latest sequence is present and then updated if needed. In addition, any non-redundant data between the records is merged into a single record 265. If the redundant sequences are associated with two separate records, the data associated with both records is merged into a single record and one unique database identifier is discarded. If redundant sequences are associated with a single record, the source information for each redundant sequence is retained and extraneous copies of the sequence discarded. In all cases the retained sequence is the latest sequence in Entrez.

In one exemplary embodiment, routine 270 comprises the annotatation of each record in the watch and primary index for proper functional classification and subclassification. In the case of records from the Primary Index, information on functional class is determined based on the functionality assigned when the record is created. For example, a given protein sequence may contain information on the functionality of that peptide, or such information was merged via a common primary identifier in routine 230 in FIG. 2A. In one exemplary embodiment, the user may determine the strength of literature support for an asserted functionality using such indicators as the citation index. The citation index for a given record will indicate the number of times a primary paper establishing the functionality of the protein has been cited in other peer reviewed journal articles. The routine may be programmed to flag those records that either do not contain associated literature support (e.g. PubMed Ids.) or have less than a specified number of cites in a citation index. The flagged records in the primary index can then be reviewed by the user for a determination on the proper functional class or subclass and confirmed or reassigned as needed. In one exemplary embodiment, the Watch Index may also be updated for annotation and topology at this step. In the case of records in the Watch Index, the official sequence identifier or accession number is used and an alignment or homology analysis is carried out using the sequence comparison methods described in routine 250. The user may then review each aligned sequence and determine if the Watch Index sequence shares enough homology and/or contains enough literature support to justify assigning the record to a particular functional class and potentially a particular subclass.

Together, routines 205-270 allow for the ‘uniformisation’ of the data so that they may be properly and adequately analyzed. In one exemplary embodiment, the purpose of the present method is to curate all records of effectors and substrates associated with a biological function in order to assess and identify specific effector and substrate relationships. The present method also provides a novel and logical process for merging disparate information related to a given record as well as integrate updated information on a particular substrate or effector as it becomes available during successive iterations of the method.

Referring now to FIG. 3, this figure illustrates an exemplary sub-method 240 of FIG. 2A, used to curate sequences that did not have a direct or obvious matching primary identifier in the reference index. Sub-routine 240 starts with step 310, in which external database identifiers associated with the protein or peptide records from the source database are obtained. These identifiers are then cross-referenced with the International Protein Index. The International Protein Index, maintained by the European Bioinformatics Institute, provides a database of cross-references between primary data sources. IPI protein sets are made for a limited number of higher eukaryotic species whose genomic sequence has been completely determined, but where there are a large number of predicted protein sequences that are not yet in UniProt. IPI takes data from UniProt and also from uncurated sources, such as predicted proteins, and combines them non-redundantly into a comprehensive proteome set for each species. If the unmatched record in question has been associated with a curated sequence (such as a UniProt record) in an IPI proteome data set, it may be possible to identify a corresponding primary identifier (i.e. RefSeq No.). If the primary identifier can be determined in step 320 by cross-referencing the IPI index, the protein or peptide record is updated in step 325 to include reference to the appropriate primary identifier and added to the primary index 235. In one exemplary embodiment, the IPI database can be reformatted so that each record is organized by primary identifier. In other words, only those records in the IPI database that contain a primary identifier (e.g. RefSeq) are retrieved along with other associated identifiers for that record and rearranged in a new table or index by primary identifier. If a primary identifier can not be determined by cross-referencing the IPI database, the record is flagged and the user notified. At this point the user may choose to curate the record at step 340. Step 340 can include, but is not limited to, running a pattern matching algorithm or sequence alignment algorithm searching the amino acid sequence of the unmatched record against amino acids sequences associated with records in the reference index. In addition, the user may decide to place the unmatched record on the watch index as described above in reference to step 245 of FIG. 2, or exclude the record from the data set.

For databases relating to proteins with enzymatic activity, the present method may also include the use of a target validation sub-method 400 comprising the generation of a protein/peptide target index and a protein/peptide substrate index. In one exemplary embodiment, records used to generate the target and substrate index come from databases specific for a particular class of effector or substance. In another exemplary embodiment, generation of the target and substrate index is executed in parallel with the steps of FIG. 2A and 2B. The target validation step is illustrated in FIG. 4. The target validation method begins with step 410, in which a protein or peptide target record is checked for literature support confirming its role as a target of an upstream enzyme. In one exemplary embodiment, the literature support can be determined using a natural language processing algorithm as described in reference to step 210 of FIG. 2. If literature support is not available the record is added to the Watch Index 250 and monitored for updates during successive iterations of routine 200. In step 420, the record is then checked to determine if information is available on how the protein or peptide is modified by its upstream effector (e.g., phosphorylated). If modification information is present, the record is processed according to sub-method 425. Further information regarding sub-method 425 is provided below in respect to FIG. 5. If no modification information is present, the record is cross-referenced with the primary index in step 430. If the record matches a record in the primary index, the record is added to the substrate index 445. If the record does not match a primary identifier in the primary index, sub-routine 240 of FIG. 2A is executed to determine if a primary identifier can be associated with the record. If a primary identifier can be associated with the record, the record is added to both the primary index 235 and the substrate index 445. If a primary identifier cannot be associated with the record after executing sub-routine 240, the record is added to the Watch Index 250. In one exemplary embodiment, if the record does not match a record in the primary index, the record is added directly to the Watch Index 250, without further processing.

Referring now to FIG. 5, which illustrates the steps of Curate Method 2 425. Method 425 begins with step 510, which executes sub-method Curate Method 1 as discussed in respect to sub-routine 240 in FIG. 3. This step insures that only sequences that have been previously validated as accurate and properly associated with a primary identifier are processed. As in FIG. 3, records that cannot be curated may be excluded from the database, or placed on a Watch Index 250 for further updating and revaluation during subsequent iterations of the primary routine 200. Next, the record is checked for the presence of information on the site of modification in step 520. If position information is not available, the record is added to the Substrate Index 445 of FIG. 4. If position information is available, the position information is validated in step 535 by checking the reported site of modification against the curated sequence. For example, if a target record lists the site of phosphorylation at the serine found at position 144, the method will verify that a serine exists at site 144 in the curated sequence. Also, if a record provides peptide information, that is information regarding the composition of amino acids flanking the modification site, the peptide will be aligned with curated sequence to determine if both the amino acid composition and site of modification match the curated sequence. If the position information is validated at step 535 the record is added to the Target Index at 450 of FIG. 4. If the position information cannot be validated, a warning is generated and the user notified at step 545. At step 545 an alignment of the reported site of modification and/or peptide sequence with the curated sequence will be presented to the user. The user may then scan the primary sequence and determine if a reasonable adjustment may be made to the site information in order to bring it into accordance with the curated sequence.

For example, kinase ERBB4 is reported in the literature to self-phosphorylate at site 770 (PubMed ID: 15863494, 18347089) and gives the peptide sequence of “SRLSPPA.” When the target was validated using the present method, it was found that the modified serine did not align with site 779. However, if the peptide was shifted downstream by one amino acid to site 780, there was strong agreement with the peptide sequence and that of the curated sequence for ERBB4. The updated position and peptide sequence information is then added to the record and noted as modified. The original position information and peptide information may also be maintained with the record for reference purposes. This process may be carried out manually or be encoded within the software so that the peptide is shifted within a predefined distance of the reported site, for example 1-10 amino acids both upstream and downstream of the reported site. After each shift the alignment is re-checked using standard pair-wise alignment algorithms known in the art, and the re-alignment providing the highest level of sequence identity is used to update the position and peptide information of the record. In one exemplary embodiment, a realignment of the peptide sequence must maintain at least 90%, 95%, or 100% sequence identity with the curated protein sequence. If the record can be further validated at step 545, the record is added to the Target Index 450 of FIG. 4. If the record can not be further validated at step 545 the record is added to the Substrate Index 445 of FIG. 4.

### Computer System

In another aspect, a computer system for searching and analyzing the protein and peptide data contained in the centralized protein database is provided. The computer system comprises, at least, a user interface and the above described database. In one exemplary embodiment the user interface is a search engine and supporting software. The user interface allows a user to search and analyze the protein and peptide data in the database. The data in the database may be subdivided into cassettes, each cassette allowing the user access to various subsets of data within the database. The computer system is cable of rendering search results as a 3D network based on various characteristics such as, but not limited to, protein-protein affinity, protein-protein specificity, protein and associated molecular pathways, and protein and associated medical conditions.

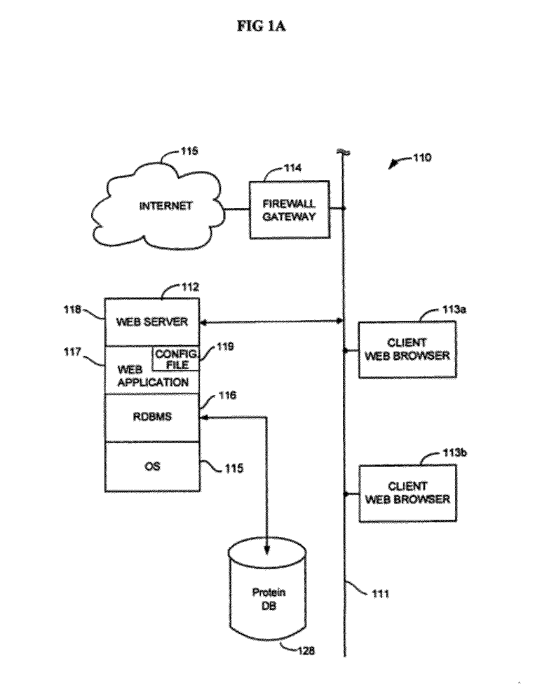

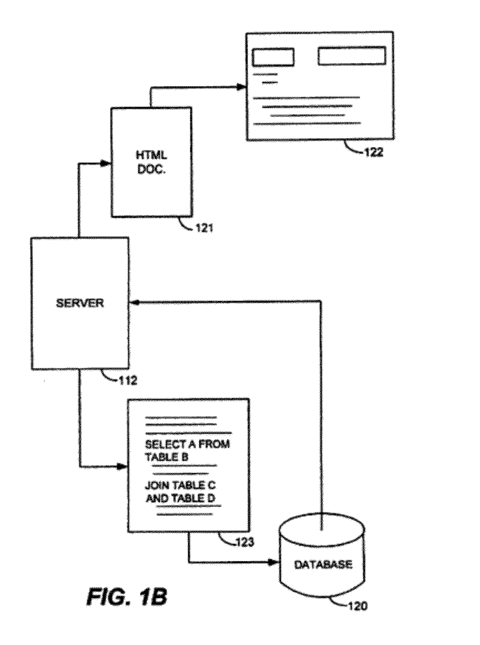

FIG. 1 depicts a computer system 110 suitable for storing and retrieving information in relational databases. Network 110 includes a network cable 111 to which a network server 112 and clients 113a and 113b (representative of possibly many more clients) are connected. Cable 111 is also connected to a firewall/gateway 114 which is in turn connected to the Internet 115.

Network 110 may be any one of a number of conventional network systems, including a local area network (LAN) or a wide area network (WAN), as is known in the art (e.g., using Ethernet, IBM Token Ring, or the like). The network includes functionality for packaging client calls in a well-known format (e.g., URL) together with any parameter information into a format (of one or more packets) suitable for transmission across a cable or wire 111, for delivery to database server 112.

Server 112 includes the hardware necessary for running software to (1) access database data for processing user requests, and (2) provide an interface for serving information to client machines 113a and 113b. In a preferred embodiment, depicted in FIG. 1, the software running on the server machine supports the World Wide Web protocol for providing page data between a server and client.

Client/server environments, database servers, and networks are well documented in the technical, trade, and patent literature. For a discussion of database servers and client/server environments generally, and SQL servers particularly, see, e.g., Nath, a., The Guide To SQL Server, 2nd ed., Addison-Wesley Publishing Co., 1995 (which is incorporated herein by reference for all purposes).

As shown, server 112 includes an operating system 115 (e.g., UNIX) on which runs a relational database management system 116, a World Wide Web application 117, and a World Wide Web server 118. The software on server 136 may assume numerous configurations. For example, it may be provided on a single machine or distributed over multiple machines.

World Wide Web application 117 includes the executable code necessary for generation of database language statements (e.g., SQL statements). Suitable application program interfaces for querying and retrieving information from the database include, but are not limited to, Perl API, R API, Bioperl API, a low-level Java API, and a low-level C++ API. Generally, the executables will include embedded SQL statements. In addition, application 117 includes a configuration file 119 which contains pointers and addresses to the various software entities that comprise the server as well as the various external and internal databases which must be accessed to service user requests. Configuration file 119 also directs requests for server resources to the appropriate hardware as may be necessary should the server be distributed over two or more separate computers.

Each of clients 113a and 113b includes a World Wide Web browser for providing a user interface to server 112. Through the Web browser, clients 113a and 113b construct search requests for retrieving data from a protein database 120. Thus, the user will typically point and click to user interface elements such as buttons, pull down menus, scroll bars, etc. conventionally employed in graphical user interfaces. The requests so formulated with the client's Web browser are transmitted to Web application 117 which formats them to produce a query that can be employed to extract the pertinent information from the database 120.

In the embodiment shown, the Web application accesses data in the protein database 120 by first constructing a query in a database language (e.g., MySQL, Sybase or Oracle SQL). The database language query is then handed to relational database management system 116 which processes the query to extract the relevant information from database 120.

The procedure by which user requests are serviced is further illustrated with reference to FIG. 1B. In this embodiment, the World Wide Web server component of server 112 provides Hypertext Mark-up Language documents (“HTML pages” and CGI) 121 to a client machine. At the client machine, the HTML or CGI document provides a user interface 122 which is employed by a user to formulate his or her requests for access to database 120. That request is converted by the Web application component of server 112 to a SQL query 123. That query is used by the database management system component of server 112 to access the relevant data in database 120 and provide that data to server 112 in an appropriate format. Server 112 then generates a new HTML document relaying the database information to the client as a view in user interface 122.

While the embodiment shown in FIG. 2A employs a World Wide Web server and World Wide Web browser for a communication between server 112 and clients 113a and 113b, other communications protocols will also be suitable. For example, client calls may be packaged directly as SQL statements, without reliance on Web application 116 for a conversion to SQL.

When network 110 employs a World Wide Web server and clients, it must support a TCP/IP protocol. Local networks such as this are sometimes referred to as “Intranets.” An advantage of such Intranets is that they allow easy communication with public domain databases residing on the World Wide Web (e.g., the GenBank World Wide Web site). Thus, in a particular preferred embodiment, clients 113a and 113b can directly access data (via Hypertext links for example) residing on Internet databases using a HTML interface provided by Web browsers and Web server 118.

Bear in mind that if the contents of the local databases are to remain private, a firewall 114 may preserve in confidence the contents of a sequence database 120.

In a preferred embodiment, the protein database includes a plurality of tables. In one specific embodiment, these tables provide information about a protein or peptide such as, but not limited to, standardized name, standardized symbol, amino acid sequence, protein-protein interactions, structure, function, localization, associated SNPs, and list of cited references.

Preferably, the information in the protein database 146 is stored in a relational format. As mentioned, it may include tables for primary information such as standardized name, standardized symbol and RefSeq numbers and additional information such as amino acid sequences, nucleotide sequences, protein interactions, protein function, protein localization, protein structure and associated SNPs. In Oracle™ databases, for example, the various tables are not physically separated, as there is one instance of work space with different ownership specified for different tables.

In a multi-user environment, where multiple searches of the database may be executed simultaneously, a dual processer server machine may be desirable. A suitable dual processor server machine may be any of the following workstations: Sun-Ultra-Sparc 2™ (Sun Microsystems, Inc. of Mountain View, Calif.), SGI-Challenge L™ (Silicon Graphics, Inc. of Mountain View, Calif.), and DEC-2100A™ (Digitial Electronics Corporation of Maynard, Mass.). Multiprocessor systems (minimum of 4 processors to start) may include the following: Sun-Ultra Sparc Enterprise 4000™, SGI-Challenge XL™, and DEC8400™ Preferably, the server machine is configured for network 130 and supports TCP/IP protocol.

Depending upon the workstation employed, the operating system may be, for example, one of the following: Sun-Sun OS 5.5 (Solaris 2 5), SGI-IRIX 5 3 (or later), or DEC-Digital UNIX 3 2D (or later).

In an exemplary embodiment, the database is provided together with a suite of functions made available to users through a collection of user interface screens (e.g. HTML pages). Typically, the interface will have a main menu page from which various lines of query can be followed. Access to the database can be limited by grouping certain types of date into cassettes. For example, a cassette may comprise all records associated with a specific protein, such as a specific kinase and respective substrates. Another cassette may comprise all records for a family of proteins, such as a family of kinases and their respective substrates. A cassette is defined at an administrator level and the computer system includes a means for determining the proper level of access for each user, such as an index containing user names and passwords and corresponding access levels. Alternatively, a cassette may represent the sub-set of data the user is allowed to download and access remotely.

A core use of the software and derivative applications is the ability to identify, elucidate and present molecular networks of a given protein or peptide and related targets and effectors. The use of the database ensures that the targets and effectors associated with a searched protein contain the most accurate information relating to their sequence, types and sites of modification, function and protein-protein interactions. When users have the proper cassette to search the database the software can elucidate classification depending on key protein-target characteristics such as affinity, specificity, or antigenicity. Based on the information stored in the database, a user will also be able to generate networks showing characteristics such as, but not limited to, a given protein and its related functional pathways, associated medical conditions, and known small molecule inhibitors. An option for the user is the ability to merge multiple networks together. The number of interactive/interconnected networks can be increased at will by the user. In one exemplary embodiment the networks are visualized as a two- or three-dimensional representation with the searched protein at the center and the outlying nodes represented the related characteristics by which the protein was searched. For example, a search of an enzyme and its related targets and substrates would generate a three dimensional network with the enzyme in the center connected to all known targets and substrates stored in the database. The nodes of the network may be active, that is they may link to additional information associated with each target or substrate. Further, the lines connecting each node may be encoded to indicate additional information. For example, the thickness of the connecting line can indicate the number of connections between two nodes. In one exemplary embodiment, the thickness of the line connecting an effector to a substrate indicates the number of times or locations the effector modifies the substrate. In another exemplary embodiment, the thickness of the line can indicate strength of association between two nodes. For example, strength of association may indicate the number of prior publications supporting the connection between an effector and substrate or vice versa.

Rendering of the two- or three-dimensional networks can be accomplished using standard software development kits (SDKs) known in the art and useful in the development of graphical user interfaces (GUI), such as Flash or Java. Exemplary GUI toolkits that may be used in generating a suitable GUI for the present computer system include, but are not limited to, wxWidgets, Juce, FLTK, FOX tookit, GTK+, IUP (software), JX Application Framework, Microsoft Foundation Classes, Motif, Object Windows Library & OWLNext, Qt, Standard Widget Tookit, Swing, Tk, Ultimate ++, Visual Component Library, and XForms. In addition, the computer system of the present invention may rely upon certain graphics libraries to aid in rendering the graphics. Examples of suitable graphics libraries which may be used with the present invention include, but are not limited to, Cairo, Direct3D, MiniGL, OpenGL, OpenGL ES, Open Inventor, Openskia, emWin, and SMFL. In one exemplary embodiment, Flash is used to render the two- and three-dimensional network representations of the results of search queries run on the computer system and database of the present invention.

In one exemplary embodiment, a user initiates a search from a main menu page. A main menu page may present the following options to a user, as search term entry field. The user may search the database for a protein by name, symbol, RefSeq number, other identifier, or sequence. The query will then be translated into an appropriate database query (i.e. SQL statement) by the relational database management software and the relevant search results retrieved. The search results may be presented in a preliminary results page. Information may initially be presented in a tabular format and may include for each protein searched, a table providing general information for the searched protein comprising, for example, protein name, database identifier, chromosome location, OMIM ID, related gene information and RefSeq numbers; a table providing an overview of the searched protein's interactivity network comprising, for example, the total number of substrates, the number of unique substrate, the number of shared substrates with other searched proteins, total number of peptides, total number of unique peptides, and total number of shared peptides; a table providing information on substrates of the search protein comprising, for example, the name of the targeted substrate, the number of peptide sites modified, upstream enzymes included in the search, upstream enzymes not included in the search, and peptide sequences comprising, for example, the site of modified by the search protein on the peptide substrate; and a table providing information on related proteins comprising, for example, related protein name and/or symbol, percent of shared substrates with searched protein, percent of shared peptides with searched protein, number of downstream substrates, number of peptide sites, and peptide sequences comprising, for example, sites of modification by the related enzyme. If there are multiple search results the user may select the appropriate protein. The user will then be able to select additional classification characteristics such as, target and substrates, functions/activities, associated molecular networks, associated disease conditions. The search results are then rendered in a two- or three-dimensional network with the searched protein at the center and the classification characteristics at the nodes. One or more networks may be merged into a single network. The networks may also be dynamic allowing the user to pull a node to the center and reconfigure the network based on the new search term. For example, an initial search of a protein and target and substrates will generate a network with that protein connected to all of its known targets or substrates. The user may then select a target of interest and drag it to the center of the network. The network will then be reconfigured to show the target at the center connected to all proteins known to modify that target at the nodes. For each individual protein in the network information such as known aliases, protein sequences, sites of modification, nucleotide sequences, domain information, three dimensional structural information, and a list of scientific literature citations may be obtained.

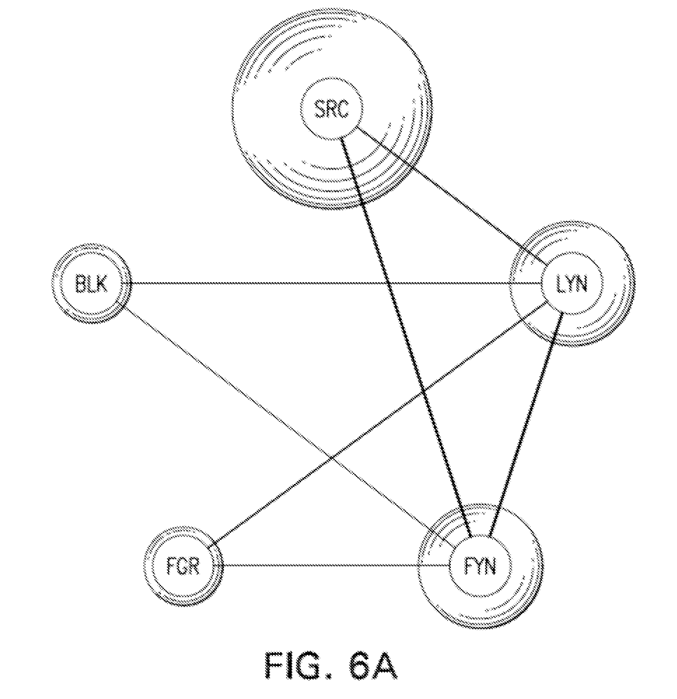

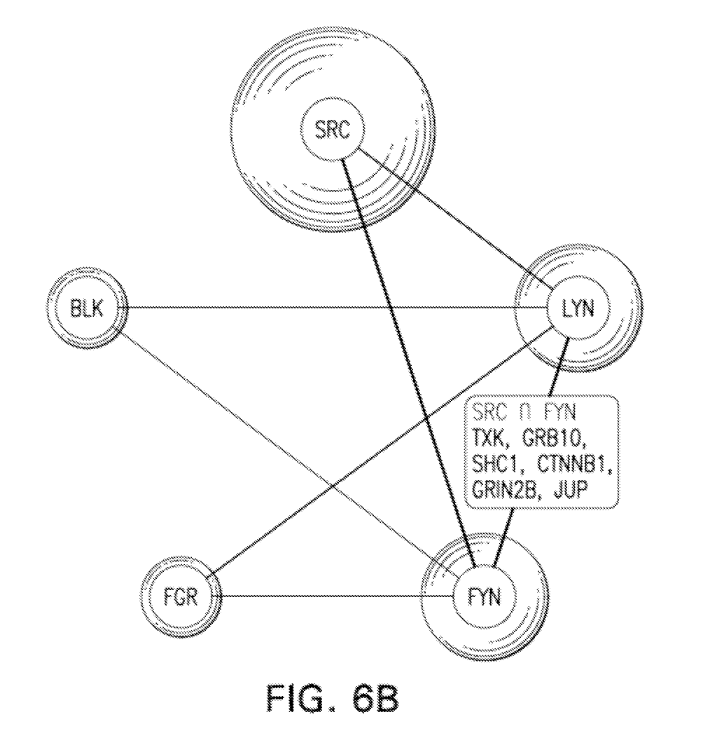

FIGS. 6-9 shows a sampling of the types of graphical representations that may be rendered using a computer system of the present invention. The graphical networks depicted in FIGS. 6-11 are exemplary in nature and are not exhaustive of all possible molecule network representations that may be generated using the present invention. The exemplary search consisted of searching the database for the kinases v-yes-1 Yamaguchi sarcoma virus related oncogene homology (LYN), FYN oncogene related to SRC, FGR, YES (FYN), v-src sarcoma Schmidt-Ruppin A-2) viral oncogene homolog (avian) (SRC), B lymphoid tyrosine kinase (BLK), and Gardner-Rasheed feline sarcoma viral (v-fgr) oncogene homolog (FGR).

FIG. 6A shows an exemplary systemic view of a multi-enzyme search. The size of the ‘cloud’ or ‘shadow’ around each enzyme gives an indication of the number of known substrates for each enzyme in the database relative to the other enzymes in the search. The lines indicate at least one shared substrate between any two enzymes, with the thickness of the lines indicative of the number of shared substrates between two enzymes relative the number of shared substrates between other enzymes in the search. As shown in FIG. 6B, hovering the mouse pointer over a line will result in the display of the names of the common substrates shared between the two enzymes. In the present example, substrates TXK, GRB10, SHC1, CTNNB1, GRIN2B, and JUP are modified by both SRC and FYN.

Alternatively, the results of the multi-enzyme search may be displayed in a nodal view. In a nodal view all substrates modified by the enzymes in the search appear along with the searched enzymes. The substrates on the periphery are specific to one of the enzymes searched but are not shared with other enzymes in the search. The graphic display is encoded so that hovering over the arrow pointing from a particular enzyme, in this case FYN, to the periphery will highlight those substrates on the periphery modified by that enzyme. Likewise the graphic display may be encoded so that hovering over a particular enzyme will highlight the common substrates shared with other enzymes in the search, and hovering over a substrate will highlight all of the enzymes in the search that modify that substrate. In this view, the thickness of the lines connecting the enzymes and substrates is encoded to be indicative of relative number of sites at which an enzyme modifies the substrates to which it is connected (i.e. a thicker line equals more sites of modification on the substrate).

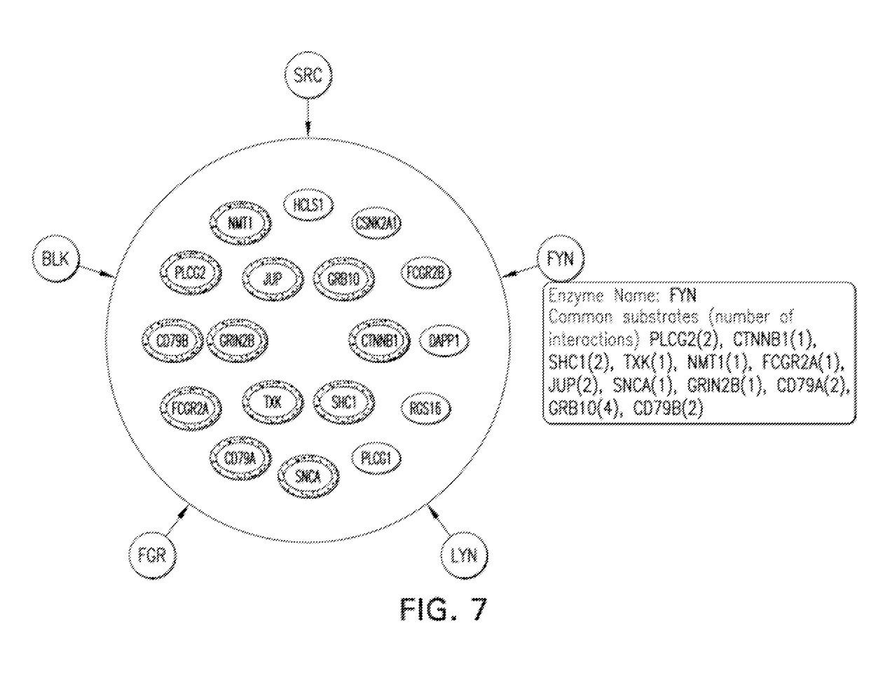

FIG. 7 shows an exemplary hub view of the above search results. The searched enzymes are on the periphery with the pool of common substrates grouped in the center. Hovering over a particular enzyme, in this case FYN, will highlight all of the substrates modified by that enzyme. Alternatively, hovering over a substrate will highlight all enzymes that modify that substrate, not shown.

The search results may also be displayed in a compact view. In a compact view the graphic display is encoded so that hovering over a given enzyme highlights the enzymes it modifies. The thickness of the lines is encoded to be indicative of the relative number of modification sites at which a given enzyme modifies that particular substrate. Conversely, hovering over a substrate highlights all of the enzymes that modify that substrate.

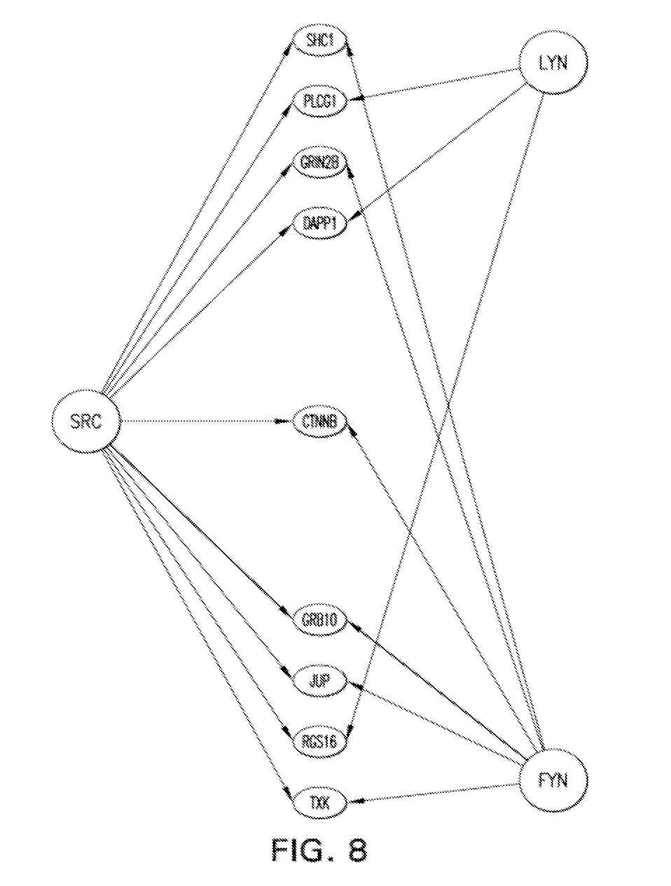

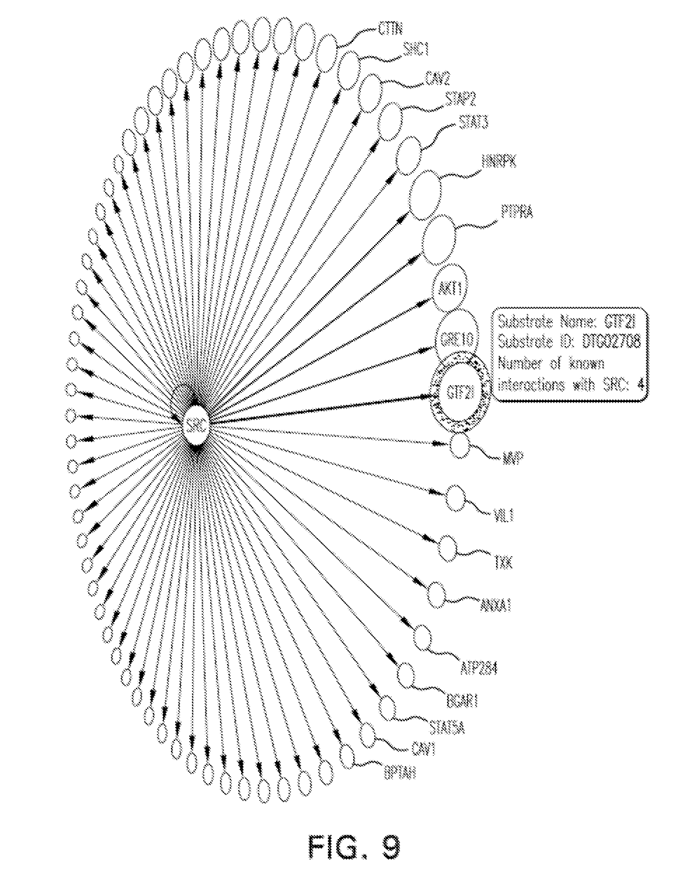

FIG. 8 show an exemplary interactive map for SRC and how it interacts with other enzymes in the search. Again the lines are encoded to be indicative of the relative number of sites at which a given enzyme modifies a particular substrate to which it is connected. As can be seen in the figure there is a particularly strong convergence of SRC and FYN on the substrate GRB10 with both enzymes modifying the substrate at multiple sites. For any given enzyme searched a three-dimensional network, such as the one shown in FIG. 9 can be generated, showing the enzyme and all modified substrates around the periphery. The network can be manipulated by the user to explore the types of substrates and the nature of the interaction/modification with the searched enzyme.

The computer system may also be configured to connect to one or more external databases so that additional information not stored directly in the database, such as genomic sequences or links to cited research articles, may be retrieved as needed. Additional external links to third party vendors, such as suppliers of reagents and research tools, may also be included and accessed from the search results.

Applications of the computer system include, but are not limited to, drug development and identification of key targets, drug optimization based on the ability to elucidate functional networks of key targets and avoid unwanted side effects, and assay design and development for biological and clinical settings. The present invention may also be used to assess or predict various biological characteristics of interest to pharmacological or biomedical development. These include data or characteristics analyzing or reporting on the changes of chemical properties of targets and substrates before and after enzymatic modification such as protein or peptide antigenicity, hydrophobicity, hydrophilicity, and prediction for 3D modeling of substrate/effector relationships.

It should be understood that the foregoing relates only to illustrative embodiments of the present systems, methods and databases. Certain modifications and improvements will occur to those skilled in the art upon a reading of the foregoing description. It should be understood that all such modifications and improvements may be made therein without departing form the spirit and scope of the subject matter as defined by the following claims.

All patents and patent publications referred to herein are hereby incorporated by reference.

1. A computer-implemented method for creating and maintaining a database for centralizing and harmonizing protein and peptide data by a functional class of protein, comprising:
a) creating, by one or more computers, a reference index;
b) identifying, by the one or more computers, records in the reference index associated with the functional class of protein;
c) adding, by the one or more computers, records identified in b) to a primary index and assigning each record a unique database identifier;
d) identifying, by the one or more computers, additional records in one or more external databases associated with the functional class of protein;
e) verifying, by the one or more computers, that the additional records contain a primary identifier, and for those records containing a primary identifier, adding the records to the primary index; and
f) associating, by the one or more computers a primary identifier with any remaining additional records and adding the remaining additional records associated with a primary identifier to the primary index.

2. The method of claim 1 further comprising one ore more of the steps of removing, by the one or more computers, redundant records, correcting, by the one or more computers, incorrect sequences associated with the records, validating, by the one or more computers, record label annotation, and adjusting, by the one or more computers, a taxonomy of the records.

3. The method of claim 1 or claim 2, wherein creating a reference index comprises merging, by the one or more computers, records from a biological sequence database and a standardized nomenclature database based on a common primary identifier.

4. The method of claim 3, wherein the biological sequence database is an Entrez database and the standardized nomenclature database is a HGNC database.

5. The method of claim 3, wherein the primary identifier is a RefSeq number.

6. The method of any one of claims 1 to 3 , wherein identifying additional records associated with the functional class of protein comprises:
a) searching, by the one or more computers, one or more scientific literature databases with one or more key words associated with the functional class of protein to identify references containing information related to the functional class of protein;
b) identifying, by the one or more computers, those records containing a name or symbol associated with the records of the reference index or external database using a natural language processing algorithm; and
c) adding, by the one or more computers, those records containing a name or symbol identified in b) to the primary index.

7. The method of any one of claims 1-3, wherein associating a primary identifier with the remaining additional records comprises for each record:
a) obtaining, by the one or more computers, the external database identifier assigned to the record;
b) cross-referencing, by the one or more computers, the International Protein Index (IPI) with the external database identifier to determine if a primary identifier can be associated with the record;
c) updating, by the one or more computers, those records for which a primary identifier is identified and adding the record to the primary index;
d) flagging, by the one or more computers, those records for which a primary identifier is not identified for manual validation.

8. The method of any one of claims 1-3, wherein the external databases are selected from the group comprising; UniProt, Ensembl, IntAct, MINT, BioGRID, APID, STRING, MiMi, and UniHI.

9. The method of any one of claims 1-3 further comprising a target validation step comprising the generation of a protein target index and a protein substrate index.

10. The method of claim 9, wherein generation of the protein target index and the protein substrate index comprises;
a) obtaining, by the one or more computers, candidate target records from data source;
b) verifying, by the one or more computers, literature support;
c) determining, by the one or more computers, if modification information is present; and
d) validating, by the one or more computers, position information.

11. The method of claim 10, wherein verifying literature support comprises
a) searching, by the one or more computers, one or more scientific literature databases with one or more key words associated with the functional class of protein to identify references containing information related to the functional class of protein; and
b) verifying, by the one or more computers, if the references identified in a) contain information related to the protein or peptide associated with the record by using a natural language processing algorithm.

12. The method of claim 10, wherein validating position information for those records where modification information is present comprises
a) associating, by the one or more computers, a primary identifier with the record;
b) determining, by the one or more computers, if position information is contained in the record, wherein those records without position information are added to the protein substrate index;
c) verifying, by the one or more computers, the position information of remaining records and adding those records for which position information is verified to the protein target index and those records for which position information could not be verified to the substrate index.

13. A computer system comprising the database of claim 1, a server, and one or more clients.

14. The computer system of claim 13, wherein the database is subdivided into cassettes, wherein each cassette defines the records which a client is allowed access to.

15. The computer system of claim 13, wherein the server comprises a web server, a web application, a relational database management system, and an operating system.

16. The computer system of claim 13, wherein the clients comprise a user interface, wherein the user interface comprises a search engine for searching the database and a graphical user interface for rendering the search results.

17. The computer system of claim 16, wherein the graphical user interface renders the search results as two or three dimensional networks, wherein a searched protein or peptide is at the center of the network.

18. The computer system of claim 13, further comprising a protein target database and a protein substrate database.

19. The computer system of claim 15, wherein the web application is linked to one or more external databases.
